(19) United States
(12) Patent Application Publication
(10) Pub. No.: US 2026/0058245 A1
(43) Pub. Date: Feb. 26, 2026

(54) BATTERY ASSEMBLY

(71) Applicant: SK On Co., Ltd., Seoul (KR)

(72) Inventors: Jeong Joo LEE, Daejeon (KR); Tak Kyung YOO, Daejeon (KR); Hae Ryong JEON, Daejeon (KR)

(21) Appl. No.: 19/260,611

(22) Filed: Jul. 7, 2025

(30) Foreign Application Priority Data
Aug. 20, 2024 (KR) 10-2024-0111048

(51) Int. Cl. H01M 10/6555; H01M 10/613; H01M 10/647; H01M 50/209; H01M 50/289; H01M 50/342; H01M 50/505; H01M 50/548

(52) U.S. Cl. CPC H01M 10/6555; H01M 10/613; H01M 10/647; H01M 50/209; H01M 50/289; H01M 50/3425; H01M 50/505; H01M 50/548

(57) ABSTRACT

A battery assembly according to the present disclosure includes a plurality of battery cells, each including an electrode assembly and a housing receiving the electrode assembly, a venting portion formed on one surface of a housing of each of the plurality of battery cells, a tab portion formed on at least one surface of the housing of each of the plurality of battery cells to connect the electrode assembly to an outside, and a battery group, wherein at least a portion of the plurality of battery cells are stacked along a first direction facing the venting portion.

### CROSS-REFERENCE TO RELATED PATENT APPLICATION

The present application claims priority under 35 U.S.C. § 119 (a) to Korean patent application number 10-2024-0111048 filed on Aug. 20, 2024 in the Korean Intellectual Property Office, the entire disclosed portion of which is incorporated by reference herein.

### BACKGROUND OF THE INVENTION

### 1. Field

The present disclosure relates to a battery assembly.

### 2. Description of the Related Art

Secondary batteries convert electrical energy into chemical energy and store the chemical energy so that the secondary batteries can be reused multiple times through charging and discharging. Secondary batteries are widely used throughout the industry due to their economical and eco-friendly characteristics. In particular, lithium secondary batteries are widely used in the entire industry, including portable devices which require high-density energy.

Over the course of repeated use, gases may build up inside a secondary battery. When the gases cannot be discharged to the outside of the secondary battery, the secondary battery may explode or catch fire. Therefore, it is essential to discharge the gases inside the secondary battery to the outside.

### SUMMARY OF THE INVENTION

An aspect of the present disclosure is to provide a battery assembly with improved stability.

In addition, another aspect of the present disclosure is to provide a battery cell assembly with improved assemblability.

In addition, the present disclosure may be widely applied in the fields of electric vehicles, battery charging stations, and other green technologies such as photovoltaics and wind power using batteries.

In addition, the present disclosure may be used in eco-friendly electric vehicles and hybrid vehicles to prevent climate change by suppressing air pollution and greenhouse fluid emissions.

A battery assembly according to embodiments of the present disclosure may include a plurality of battery cells, each including an electrode assembly and a housing receiving the electrode assembly, a venting portion formed on one surface of a housing of each of the plurality of battery cells, a tab portion formed on at least one surface of the housing of each of the plurality of battery cells to connect the electrode assembly to an outside, and a battery group, wherein at least a portion of the plurality of battery cells are stacked along a first direction facing the venting portion.

The tab portion may be formed toward a second direction perpendicular to the first direction.

The venting portion of each battery cell located at an outermost side of the battery group along the first direction may be arranged to face outwardly.

The battery group may include a plurality of battery groups, and the plurality of battery groups may be arranged along a third direction perpendicular to each of the first direction and the second direction.

The tab portion may include a first tab and a second tab each connected to the electrode assembly, and the first tab and the second tab may be formed in opposite directions to each other.

The battery assembly may further include a busbar assembly electrically connecting the plurality of battery cells.

The busbar assembly may be arranged to oppose the tab portion of each of the plurality of battery cells along the second direction.

The battery assembly may further include a cooling member cooling the plurality of battery cells.

The cooling member may be arranged between two adjacent battery cells among the plurality of battery cells.

The cooling member may be arranged between one battery cell and another battery cell included in the battery group.

The cooling member may be inserted into the busbar assembly.

The battery assembly may further include a receiving case receiving the plurality of battery cells.

The receiving case may include a through portion in a region corresponding to the venting portion.

The battery assembly may further include an insulating member arranged between the plurality of battery cells.

The insulating member may be arranged between one battery cell and another battery cell included in the battery group.

### BRIEF DESCRIPTION OF THE DRAWINGS

FIG. 1 illustrates a battery cell according to one embodiment of the present disclosure.

FIG. 2 is an exploded view of a battery cell according to one embodiment of the present disclosure.

FIG. 3 illustrates a battery assembly according to one embodiment of the present disclosure.

FIGS. 4 and 5 illustrate a battery assembly according to one embodiment of the present disclosure.

FIGS. 6 and 7 illustrate a battery assembly according to another embodiment of the present disclosure.

FIGS. 8 and 9 illustrate a battery assembly according to another embodiment of the present disclosure.

FIG. 10 illustrates a battery assembly according to another embodiment of the present disclosure.

FIG. 11 illustrates a battery assembly according to another embodiment of the present disclosure.

### DETAILED DESCRIPTION

Hereinafter, the present disclosure will be described in detail with reference to the accompanying drawings. This is, however, illustrative only and not intended to limit the disclosed portion to the specific embodiments illustratively described.

The specific terms used herein are for convenience of description only and are not intended to be limiting exemplary embodiments.

For example, expressions such as “same” and “being same” indicate not only a state in which they are strictly the same, but also a state in which there is a tolerance or a difference in the degree to which the same function is obtained.

For example, expressions indicating relative or absolute arrangement such as “in a direction,” “along a direction,” “in parallel,” “vertically,” “centrally,” “concentrically,” or “coaxially” not only strictly indicate such arrangements, but also indicate a state of relative displacement with tolerances or an angle or distance to the extent that the same function is obtained.

To explain the present disclosure, descriptions below may be based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for the purpose of explanation, so that the present disclosure may be clearly understood. The directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an embodiment that includes only a second component without a first component may also be implemented.

It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise.

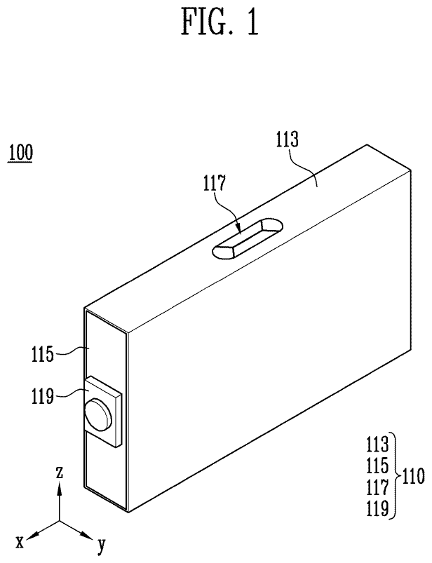

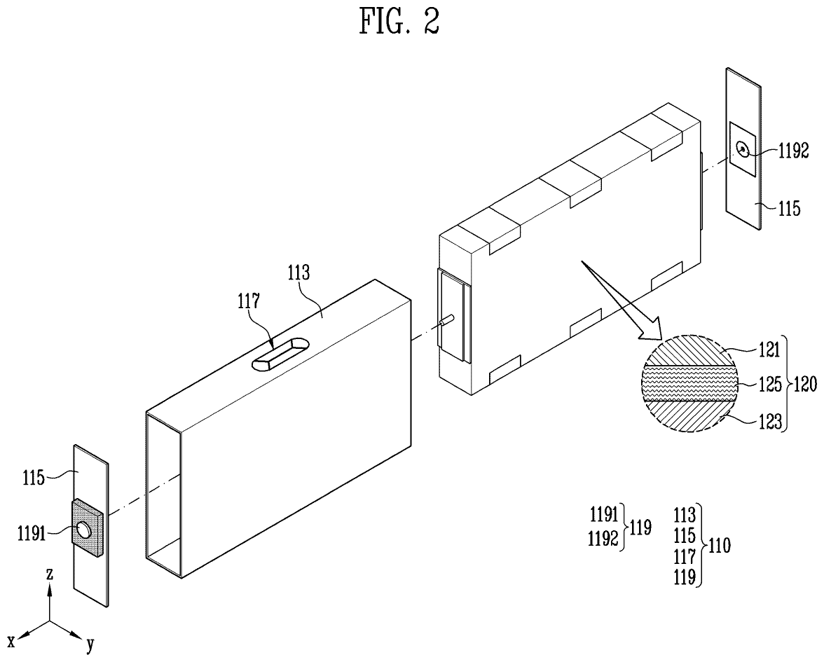

FIG. 1 illustrates a battery cell 100 according to one embodiment of the present disclosure, and FIG. 2 is an exploded view of the battery cell 100 according to one embodiment of the present disclosure.

The battery assembly 10 of the present disclosure includes a plurality of battery cells 100 each including an electrode assembly 120 and a housing 110 receiving the electrode assembly 120; a venting portion 117 formed on one surface of the housing 110 of each of the plurality of battery cells 100; a tab portion 119 formed on at least one surface of the housing 110 of each of the plurality of battery cells 100 to connect the electrode assembly 120 to the outside; and a battery group 150 in which at least a portion of the plurality of battery cells 100 are stacked along a first direction facing the venting portion 117.

The battery cell 100 may refer to a secondary battery which may be used repeatedly by charging and discharging electrical energy. In one example, the battery cell may refer to a lithium secondary battery or a lithium-ion battery, but the present disclosure is not limited thereto. As another example, the battery cell may refer to a solid-state battery.

The battery cell 100 may be categorized as a pouch secondary battery, a prismatic secondary battery, or a cylindrical secondary battery, based on the shape thereof. For ease of description, a prismatic secondary battery is shown herein as an example, but the present disclosure is not limited thereto.

The battery assembly 10 described herein may mean that the battery cells 100 are grouped in one or more numbers and placed in a receiving case 300 to protect the grouped battery cells from external shock, heat, vibration, and the like, and to obtain high power and high capacity characteristics.

In embodiments, the battery assembly 10 may have a cell-to-pack structure which includes the plurality of battery cells 100 in the single receiving case 300.

In other embodiments, the battery assembly 10 may not be a cell-to-pack structure, but rather a structure including a plurality of battery modules. The battery assembly 10 may be manufactured by first manufacturing battery modules by grouping and receiving the plurality of battery cells 100 in individual module cases, and then placing the manufactured battery modules into a single pack case.

The battery cell 100 includes the electrode assembly 120 and the housing 110 which houses the electrode assembly 120. The plurality of battery cells 100 may each include the electrode assembly 120 and the housing 110.

The electrode assembly 120 may generate electrical energy through an electrochemical reaction. The electrode assembly 120 may include an electrode. The electrode may include an electrode active material. The electrode may include a cathode 121 and an anode 123.

The electrode assembly 120 may further include a separator 125. The separator 125 may prevent a short-circuit of the cathode 121 and the anode 123. In embodiments, the separator 125 may be arranged between the cathode 121 and the anode 123. The separator 125 may include, but is not limited to, a porous polymeric film.

The housing 110 may form a receiving space therein. The receiving space may house the electrode assembly 120. The housing 110 may include a body portion 113 and a cap portion 115.

The body portion 113 may include an opening on at least one surface. The electrode assembly 120 may be inserted into the body portion 113 through the opening.

The opening may be formed on one surface of the body portion 113 and another surface opposite the one surface. The body portion 113 may be formed in the shape of a hexahedron.

The cap portion 115 may be coupled to the body portion 113. The cap portion 115 may be coupled to the body portion 113 to cover the receiving space. The cap portion 115 may be inserted into the opening and coupled to the body portion 113. In embodiments, the cap portion 115 may close the opening after the electrode assembly 120 is inserted into the body portion 113 through the opening.

In an embodiment, the tab portion 119 may be formed toward a second direction perpendicular to the first direction.

For example, the battery cell 100 may include the tab portion 119 which protrudes from the housing 110 and connects the electrode assembly 120 to the outside. The plurality of battery cells 100 may each include the tab portion 119.

One end of the tab portion 119 may be connected to the electrode assembly 120 inside the housing 110, and another end of the tab portion 119 may protrude outside the housing 110. The tab portion 119 may include a first tab 1191 and a second tab 1192 which are each connected to the electrode assembly 120. The first tab 1191 and the second tab 1192 may be formed facing in opposite directions.

Referring to FIGS. 1 and 2, the first tab 1191 may protrude along an X-axis direction from one surface of the housing 110. Additionally, the second tab 1192 may protrude along the X-axis direction from the other surface of the housing 110.

The battery cell 100 may further include the venting portion 117. The venting portion 117 may be formed on one surface of the housing 110. The venting portion 117 may be formed on one surface of the body portion 113. The venting portion 117 may be provided in the form of a groove from an outer surface of the body portion 113 toward the interior. In other words, the venting portion 117 may be provided in the form of a groove which is depressed toward the interior from the outer surface. In embodiments, the venting portion 117 may be a notch.

The battery cell 100 may be used multiple times by repeatedly charging and discharging. The gases generated during this process may increase the internal pressure of the battery cell 100. When the gases are not discharged, there is a risk of explosion of the battery cell 100. Therefore, it is necessary to discharge the gases generated inside the battery cell 100 to the outside to ensure stable use of the battery cell 100.

The venting portion 117 may be formed on one surface of the housing 110, and gas may be discharged through the venting portion 117. When the internal pressure of the housing 110 increases, the shape of the venting portion 117 may change. The venting portion 117 may open to allow the gas to be discharged to the outside of the housing 110. In this manner, the gas may be directed to flow along a path desired by a user.

The venting portion 117 may be formed on different sides of the tab portion 119 and the housing 110. When the venting portion 117 is formed on one surface of the housing 110, the tab portion 119 may be formed on a surface on which the venting portion 117 is not formed.

In the present disclosure, a direction facing the venting portion 117 may be defined as the first direction. The tab portion 119 may be formed facing a second direction perpendicular to the first direction. Referring to FIGS. 1 and 2, the first direction may refer to a Z-axis direction and the second direction may refer to the X-axis direction.

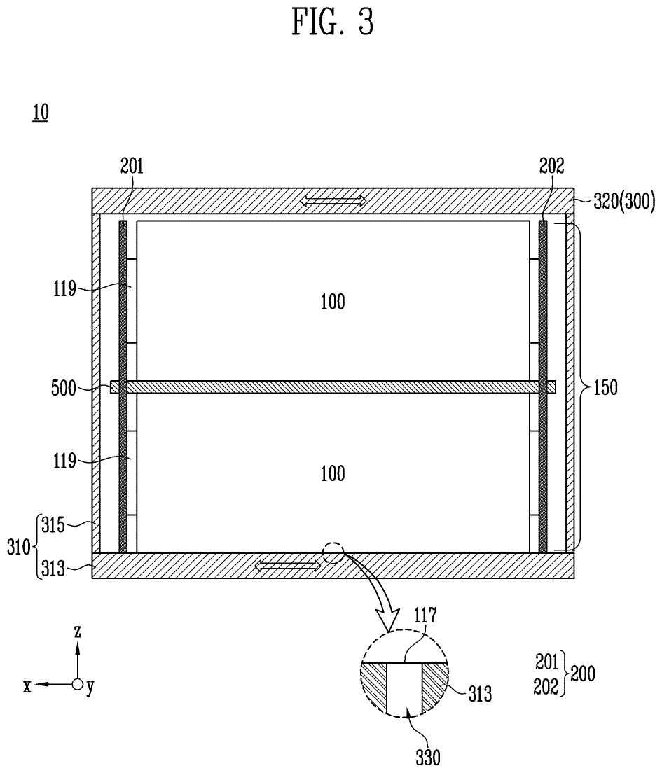

FIG. 3 illustrates the battery assembly 10 according to one embodiment of the present disclosure. Specifically, FIG. 3 illustrates a front view of the battery assembly 10.

The battery assembly 10 may further include the receiving case 300. The receiving case 300 may receive the plurality of battery cells 100. The receiving case 300 may include a support body 310 and a cover body 320. The support body 310 may be coupled to the cover body 320. The support body 310 and the cover body 320 may be coupled to protect the plurality of battery cells 100 located therein from external heat, vibration, or shock.

The support body 310 may support the plurality of battery cells 100. The support body 310 may include a lower body 313. The plurality of battery cells 100 may be arranged on the lower body 313. The support body 310 may further include a side body 315. The side body 315 may cover the sides of the plurality of battery cells 100.

The side body 315 may extend from the lower body 313 in the direction in which the plurality of battery cells 100 are located. In embodiments, the side body 315 may extend upwardly from a corner of the lower body 313.

The cover body 320 may cover the plurality of battery cells 100. In embodiments, the cover body 320 may be coupled to the side body 315. The lower body 313, the side body 315, and the cover body 320 may be combined to form a hexahedral shape with an open front and back.

In other embodiments, the side body 315 may not be provided separately. When the prismatic battery cell 100 is used, the housing 110 of the battery cell 100 may include a highly rigid material. Since the housing 110 of the battery cell 100 has a high stiffness, it is not necessary to provide a side housing 110 separately, which may reduce weight.

In embodiments, the battery cell 100 may further include an end plate (not shown). The end plate may be coupled to the receiving case 300. In embodiments, the end plate may be coupled to the receiving case 300 at front and rear. Referring to FIG. 3, the end plate may be coupled to the receiving case 300 in a Y-axis direction.

The receiving case 300 may include a through portion 330 in a region corresponding to the venting portion 117. The battery cell 100 disposed on the lower body 313 may be arranged. The through portion 330 may be formed in a region corresponding to the venting portion 117 of the disposed battery cell 100. The through portion 330 may be provided as a plurality of through portions.

The gas discharged from the battery cell 100 may travel through the through portion 330. The gas may travel through the through portion 330 to the interior of the receiving case 300. In other words, a venting path may be formed through the interior of the receiving case 300.

Specifically, FIG. 3 illustrates a view before the venting portion 117 is opened. The gas in the battery cell 100 may not be discharged to the outside. However, when the pressure inside the battery cell 100 increases, the venting portion 117 may be opened and the gas may be discharged through the opened venting portion 117. The discharged gas may travel along the interior of the lower body 313 through the through portions 330.

While FIG. 3 illustrates only the through portion 330 formed in the lower body 313, the through-hole 330 may also be formed in the cover body 320.

At least a portion of the plurality of battery cells 100 may be stacked along the first direction facing the venting portion 117 to form the battery group 150. Referring to FIG. 3, at least a portion of the plurality of battery cells 100 may be stacked along the Z-axis direction. By stacking the plurality of battery cells 100 along the first direction, the energy density of the battery assembly 10 may be improved.

In an embodiment, the battery assembly 10 may further comprise an insulating member 500 arranged between the plurality of battery cells 100.

For example, the battery assembly 10 of the present disclosure may include an insulating member 500. The insulating member 500 may retard heat propagation. The thermal conductivity of the insulating member 500 may have a lower value than a predetermined value.

The insulating member 500 may be arranged between one battery cell 100 and another battery cell 100 included in the battery group 150. The insulating member 500 may be positioned between two neighboring battery cells 100 along the first direction. In this manner, the insulating member 500 may retard heat propagation along the first direction.

Referring to FIG. 3, if heat or fire occurs in the upper battery cell 100 along the Z-axis direction, the heat or fire may not be transferred to the lower battery cell 100.

Along the first direction, the venting portion 117 of the battery cell 100 located at the bottom of the battery group 150 may be arranged to face downward, and the venting portion 117 of the battery cell 100 located at the top of the battery group 150 may be arranged to face upward.

The venting portion of each battery cell located at the outermost side of the battery group along the first direction may be arranged to face outward. Referring to FIG. 3, the venting portion 117 of the battery cell 100 positioned at the uppermost end along the Z-axis direction may be arranged to face upward. The venting portion 117 of the battery cell 100 positioned at the bottom end may be arranged to face downward.

By arranging the battery cells 100 in this structure, venting paths may be formed at the upper and lower portions of the battery group 150, respectively. The venting paths may be formed in the upper and lower portions of the battery group 150, respectively, to enable efficient venting.

The battery assembly 10 may further include a busbar assembly 200 electrically connecting the plurality of battery cells 100.

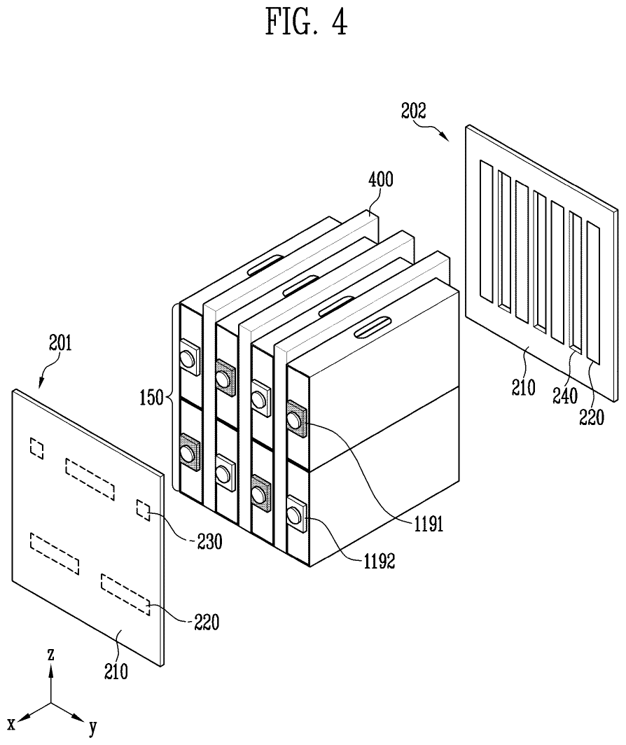

The busbar assembly 200 may be arranged to oppose each of the tab portions 119 of the plurality of battery cells 100 along the second direction. The tab portion 119 may be inserted into the busbar assembly 200 so that the tab portion 119 and the busbar assembly 200 may be stably connected. The structure of the busbar assembly 200 will be described in detail below with reference to FIGS. 4 to 11.

The busbar assembly 200 may include a busbar 220. The busbar 220 may include an electrically conductive material. The busbar 220 may electrically connect the plurality of battery cells 100. The busbar 220 may be electrically connected to each tab portion 119 of two neighboring battery cells 100.

The busbar assembly 200 may further include a busbar frame 210. The busbar 220 may be secured to the busbar frame 210. The busbar frame 210 may include an insulating material.

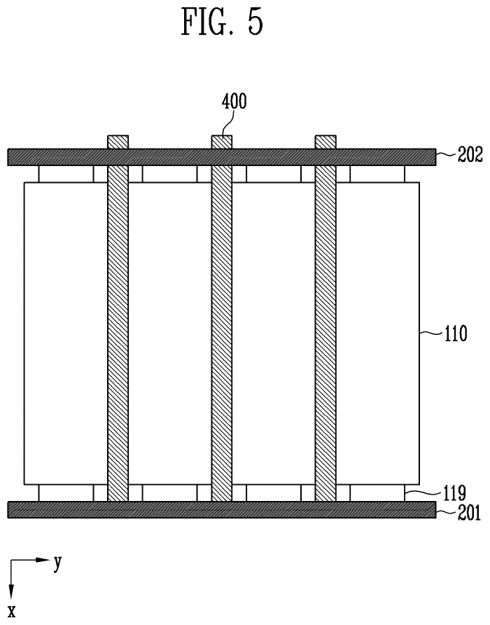

FIGS. 4 and 5 illustrate the battery assembly 10 according to one embodiment of the present disclosure.

The battery group 150 may include a plurality of battery groups, and the plurality of battery groups 150 may be arranged along a third direction perpendicular to each of the first direction and the second direction.

Two battery cells 100 may be stacked along the first direction to form the battery group 150. The battery group 150 may be arranged along the third direction. Eventually, the plurality of battery cells 100 may be arranged along the first direction and the third direction. Referring to FIG. 4, the third direction may refer to the Y-axis direction.

The busbar assembly 200 may be arranged to face the plurality of battery cells 100 along the second direction. The busbar assembly 200 may include a first busbar assembly 201 arranged on one side of the plurality of battery cells 100 and a second busbar assembly 202 arranged on the other side of the plurality of battery cells 100. The busbar 220 of the first busbar assembly 201 and the busbar 220 of the second busbar assembly 202 may be arranged differently from each other.

The busbar assembly 200 may include a terminal portion 230. The terminal portion 230 may be electrically connected to an external device.

The plurality of battery cells 100 may be electrically connected differently, depending on the arrangement of the busbar 220 of the first busbar assembly 201 and the arrangement of the busbar 220 of the second busbar assembly 202.

Referring to FIG. 4, the first tabs 1191 of the battery cells 100 included in the battery group 150 may be arranged in opposite directions. On the basis of the left-most battery group 150, the first tab 1191 of the upper battery cell 100 may be arranged facing the front, and the first tab 1191 of the lower battery cell 100 may be arranged facing the rear.

The busbar 220 of the first busbar assembly 201 may extend along the third direction. The busbar 220 of the second busbar assembly 202 may extend along the first direction. This structure allows the plurality of battery cells 100 to be connected in series with each other. The arrangement structure of the busbar 220 of the first busbar assembly 201 and the busbar 220 of the second busbar assembly 202 may be changed to obtain a desired output and performance by a user.

In an embodiment, the battery assembly 10 further comprises a cooling member 400 cooling the plurality of battery cells 100.

For example, the battery assembly 10 may further include a cooling member 400. The cooling member 400 may be in contact with the battery cell 100 to cool the battery cell 100. The cooling member 400 may be configured in a variety of ways. In an embodiment, the cooling member 400 may include a flow path through which a refrigerant flows. The refrigerant may be, but is not limited to, air or water.

The cooling member 400 may be arranged between two neighboring battery cells 100 of the plurality of battery cells 100. The cooling member 400 may contact each of the neighboring battery cells 100 to thereby reduce the temperature of the battery cell 100.

In one aspect, the cooling member 400 may be inserted into the busbar assembly 200. By inserting the cooling member 400 into the busbar assembly 200, structural stability may be improved. The busbar assembly 200 may further include an insertion portion 240. The insertion portion 240 may be formed through the busbar frame 210. The insertion portion 240 may correspond to the shape of the cooling member 400. The insertion portion 240 may be formed by penetrating the busbar frame 210 along the second direction. Referring to FIG. 4, the cooling member 400 may be inserted into the insertion portion 240.

FIG. 5 is a top view of the battery assembly 10 of FIG. 4. The cooling member 400 may be arranged between the battery groups 150 arranged along the third direction. Further, the cooling member 400 may penetrate the insertion portion 240, and one end of the cooling member 400 may protrude outwardly of the busbar assembly 200.

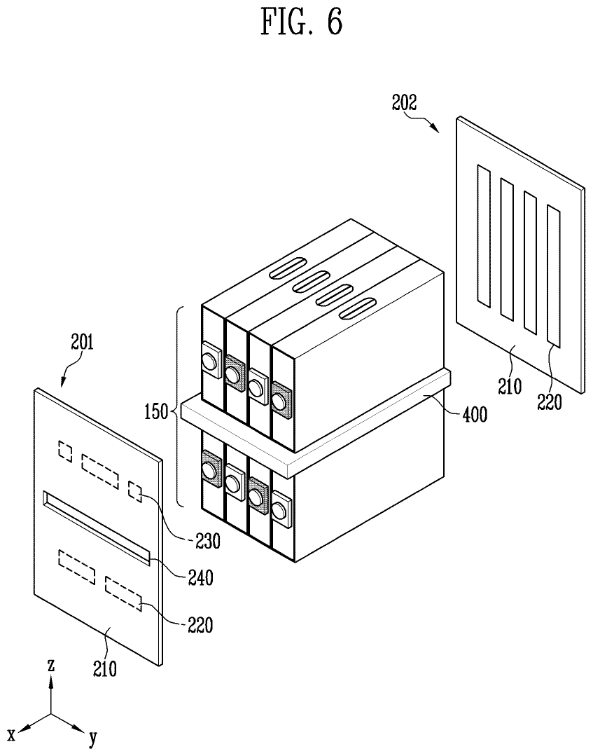

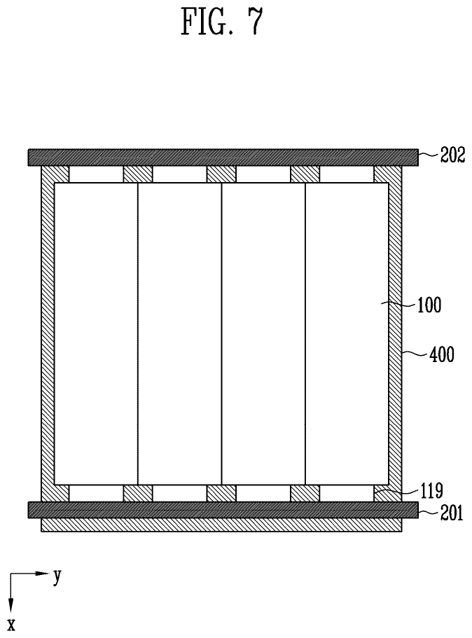

FIGS. 6 and 7 illustrate the battery assembly 10 according to another embodiment of the present disclosure.

The battery assembly 10 shown in FIG. 6 is the same as the battery assembly 10 shown in FIG. 4, except for the location of the cooling member 400. The cooling member 400 may be arranged between one battery cell 100 and another battery cell 100 included in the battery group 150. That is, the cooling member 400 may be arranged between two neighboring battery cells 100 along the first direction.

The cooling member 400 may also extend along the third direction. The cooling member 400 may be formed in the shape of a plate. The cooling member 400 may separate the battery cells 100 located at the top of each battery group 150 from the battery cell 100 located at the bottom thereof.

In embodiments, the cooling member 400 may include a material with high mechanical stiffness. Thus, the structural stability may remain high even when the cooling member 400 is stacked in the first direction of the battery cell 100.

Alternatively, the insulating member 500 may be located in place of the cooling member 400. The heat propagation may be delayed in the event of a fire in either the upper battery cell 100 or the lower battery cell 100.

Referring to FIG. 6, the insertion portion 240 may be formed in the first busbar assembly 201 because the cooling member 400 extends along the third direction.

Because the busbar 220 of the second busbar assembly 202 extends along the first direction, the insertion portion 240 cannot be formed along the third direction.

FIG. 7 illustrates a top view of the busbar assembly 200 of FIG. 6. The cooling member 400 may be arranged between the battery cell 100 located at the bottom of the battery group 150 and the battery cell 100 located at the top thereof. One end of the cooling member 400 may protrude outwardly through the insertion portion 240 of the first busbar assembly 201.

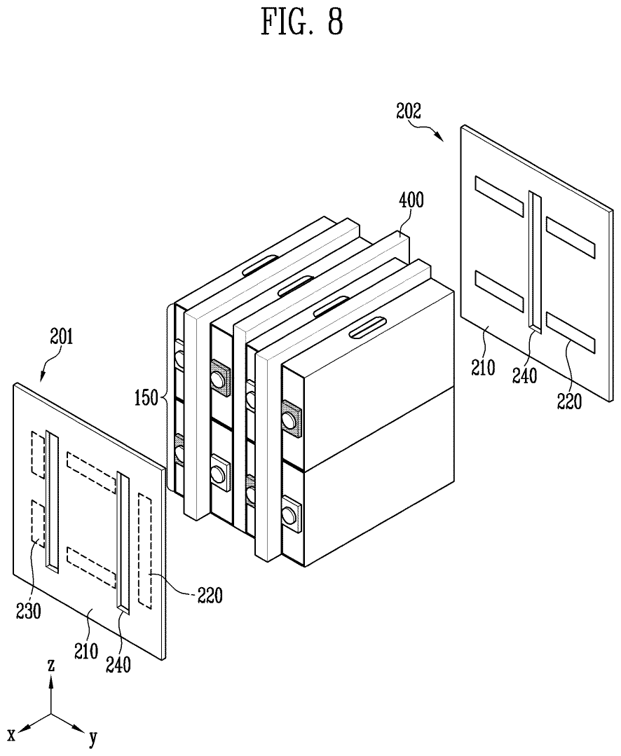

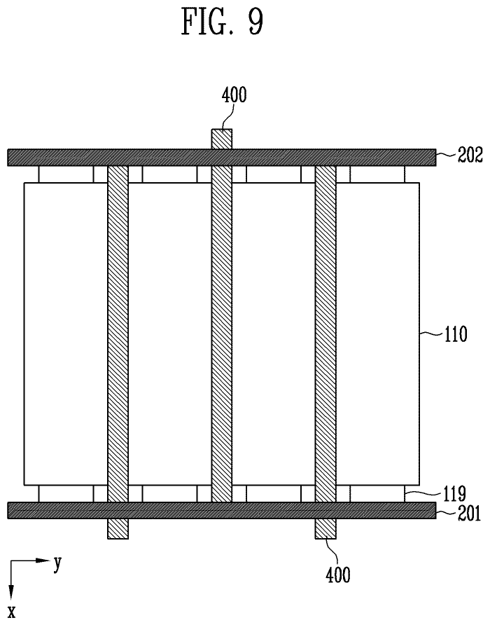

FIGS. 8 and 9 illustrate the battery assembly 10 according to another embodiment of the present disclosure.

The battery assembly 10 shown in FIG. 8 is the same as the battery assembly 10 shown in FIG. 4, except for the first busbar assembly 201 and the second busbar assembly 202. The battery assembly 10 shown in FIG. 4 has the terminal portions 230 arranged at both ends of the first busbar assembly 201. Referring to FIG. 8, the terminal portions 230 may be arranged together at one end of the first busbar assembly 201. Also, the arrangement structure of the busbar 220 may be changed so as to change the output of the plurality of battery cells 100.

In some embodiments, the cooling member 400 may be provided as a plurality of cooling members. In addition, one of the plurality of cooling members 400 may be inserted into the first busbar assembly 201 and another cooling member may be inserted into the second busbar assembly 202. Referring to FIG. 8, two of the cooling members 400 may be inserted into the first busbar assembly 201 and one of the cooling members 400 may be inserted into the second busbar assembly 202. In this manner, the plurality of battery cells 100 may be reliably electrically connected and at the same time, structural stability may also be improved.

FIG. 9 is a top view of the battery assembly 10 shown in FIG. 8. Two cooling members 400 may protrude outwardly through the insertion portion 240 of the first busbar assembly 201, and one cooling member 400 may protrude outwardly through the insertion portion 240 of the second busbar assembly 202.

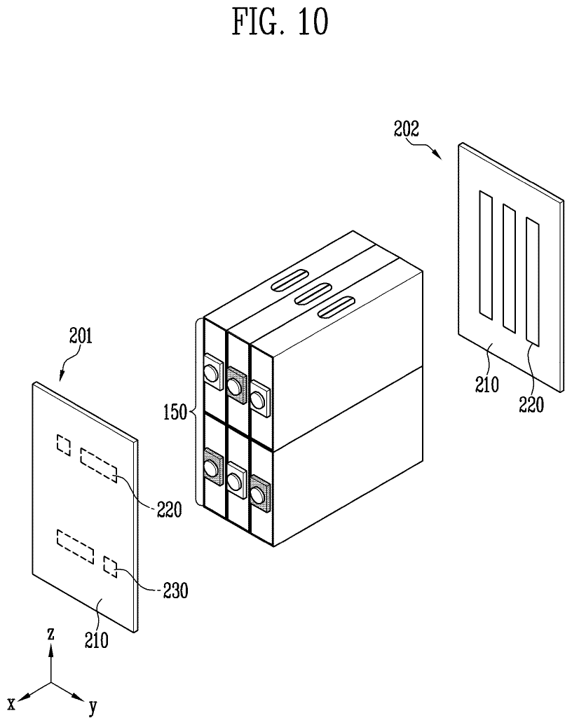

FIG. 10 illustrates the battery assembly 10 according to another embodiment of the present disclosure.

When compared to the battery assembly 10 of FIG. 4, the battery assembly 10 of FIG. 10 is shown as including an odd number of battery groups 150. The terminal portions 230 of the first busbar assembly 201 may be provided at both ends, and the busbar 220 for electrically connecting the plurality of battery cells 100 may be arranged thereon.

Although the cooling member 400 is not shown, the cooling member 400 may be provided. Since the busbar 220 of the second busbar assembly 202 extends along the first direction, it may be desirable for the insertion portion 240 to be formed in the second busbar assembly 202.

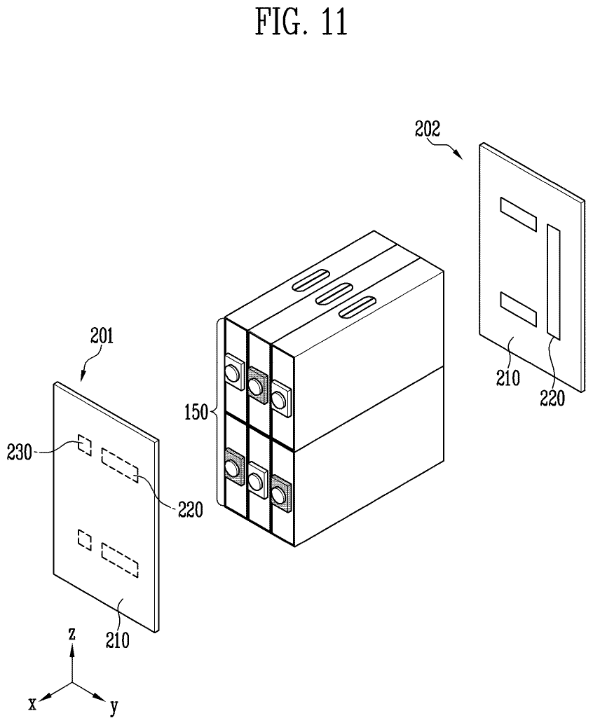

FIG. 11 illustrates the battery assembly 10 according to another embodiment of the present disclosure.

The battery assembly 10 shown in FIG. 11 is the same as the battery assembly 10 shown in FIG. 10, except for the first busbar assembly 201 and the second busbar assembly 202. The battery assembly 10 shown in FIG. 10 has the terminal portions 230 arranged at both ends of the first busbar assembly 201. Referring to FIG. 11, the terminal portions 230 may be arranged together at one end of the first busbar assembly 201. In addition, the arrangement structure of the busbar 220 may be changed to electrically connect the plurality of battery cells 100.

The cooling member 400 may also be provided. The insertion portion 240 may be formed between the busbars 220 of the first busbar assembly 201. The cooling member 400 may be inserted into the insertion portion 240 of the first busbar assembly 201.

The cooling member has been described above with reference to FIGS. 4 to 11. However, an insulating member may replace the cooling member. That is, the insulating member may be inserted into the busbar assembly and arranged between the plurality of battery cells.

According to one embodiment of the present disclosure, a battery assembly with improved stability may be provided.

In addition, a battery assembly with improved assemblability may be provided.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery assembly, comprising:
a plurality of battery cells, each including an electrode assembly and a housing receiving the electrode assembly;
a venting portion formed on one surface of a housing of each of the plurality of battery cells;
a tab portion formed on at least one surface of the housing of each of the plurality of battery cells to connect the electrode assembly to an outside; and
a battery group, wherein at least a portion of the plurality of battery cells are stacked along a first direction facing the venting portion.

2. The battery assembly according to claim 1, wherein the tab portion is formed toward a second direction perpendicular to the first direction.

3. The battery assembly according to claim 2, wherein the venting portion of each battery cell located at an outermost side of the battery group along the first direction is arranged to face outwardly.

4. The battery assembly according to claim 2, wherein the battery group comprises a plurality of battery groups, and the plurality of battery groups are arranged along a third direction perpendicular to each of the first direction and the second direction.

5. The battery assembly according to claim 2, wherein the tab portion comprises a first tab and a second tab each connected to the electrode assembly, and the first tab and the second tab are formed in opposite directions to each other.

6. The battery assembly according to claim 2, further comprising a busbar assembly electrically connecting the plurality of battery cells.

7. The battery assembly according to claim 6, wherein the busbar assembly is arranged to oppose the tab portion of each of the plurality of battery cells along the second direction.

8. The battery assembly according to claim 6, further comprising a cooling member cooling the plurality of battery cells.

9. The battery assembly according to claim 8, wherein the cooling member is arranged between two adjacent battery cells among the plurality of battery cells.

10. The battery assembly according to claim 9, wherein the cooling member is arranged between one battery cell and another battery cell included in the battery group.

11. The battery assembly according to claim 8, wherein the cooling member is inserted into the busbar assembly.

12. The battery assembly according to claim 1, further comprising a receiving case receiving the plurality of battery cells.

13. The battery assembly according to claim 12, wherein the receiving case comprises a through portion in a region corresponding to the venting portion.

14. The battery assembly according to claim 2, further comprising an insulating member arranged between the plurality of battery cells.

15. The battery assembly according to claim 14, wherein the insulating member is arranged between one battery cell and another battery cell included in the battery group.
